(19) United States
(12) Patent Application Publication
(10) Pub. No.: US 2009/0009951 A1
(43) Pub. Date: Jan. 8, 2009

(54) Calculator cover

(76) Inventor: Yahya Hassan Sbaiti, Vienna, VA (US)

Correspondence Address: General Counsel, P.C., 6862 Elm Street, SUITE 800, McLean, VA, 22101, US

(21) Appl. No.: 11/825,235

(22) Filed: Jul. 5, 2007

(51) Int. Cl. G06F 1/16

(52) U.S. Cl. 361/683

(57) ABSTRACT

A rigid calculator cover with one or more aperture(s) corresponding to geometric contours. The geometric contours may include a straight line; a geometric shape, e.g. a circle, square, rectangle, triangle, pentagon, hexagon, octagon, ellipse, arc, and the like; a protractor-replicated aperture; alphanumeric characters; figures; and other any other shape relevant to higher education, particularly math.

### FIELD OF THE INVENTION

The present invention relates to the field of teaching supplies and more specifically to the field of supports for calculators

### BACKGROUND

Through two decades of teaching various levels of mathematics courses to high school students and to students at the college level, the use of calculators, geometry sets, and graph sheets has always been an integral part of learning the subject matter. The ability to draw representations of various sorts of triangles, circles, and other geometric shapes was enforced throughout the learning process. Students were at least expected to be able to draw straight lines, triangles, and circles; this required them to carry a ruler or a straight edge of some sort.

Due to space concerns associated with lockers dimensioned to include only the bare essentials and the physical restraints on the amount of baggage that a student can or will tote at any given time, the majority of students do not carry rulers or straight edges. Student-issued geometry sets are too frequently lost, forgotten, or misplaced or broken due to the frailty of the materials from which they are constructed—rendering them useless. Students, however, will often have their calculators (their own, or ones supplied by the school system).

Therefore, there is a need for a device that allows a student more convenient access to drawing implements.

### SUMMARY

Most high schools require the use of the graphing calculator series TI-83 Plus, TI-84, or TI-89. The Ti-83 Plus has been replaced by the more versatile TI-84 and TI-89, upon which most schools will eventually rely. In ensuring that students have convenient access to geometric tools, the present invention particularly focuses on calculator covers adapted to fit particularly these two types of calculators, but is applicable to any calculator possessing a hard cover.

The present invention is directed to a calculator cover for protecting a calculator, particularly those of graphing variety. These hard-covered calculators include covers with side-mounted protrusions that fit into an indented track within the side of the calculator. The calculator cover of the present invention is a cover body constructed of a rigid material. Within the body is at least one aperture allows a pencil or pen to trace a geometric contour. The geometric contours of the present invention can include a straight line; a geometric shape, e.g. a circle, square, rectangle, triangle, pentagon, hexagon, octagon, ellipse, arc, and the like; a protractor-replicated aperture; alphanumeric characters; figures; and any other shape relevant to higher education, particularly math.

As many of the geometric contours include shape useful in their relation to units, graduations may be included on the body proximate to their associated apertures. For example, embodiments of the present invention having apertures that form a straight edge may include graduations indicating distance. It is preferred that the body of the present invention be constructed of a translucent material that maintains sufficient thickness to protect the expensive calculator within.

Therefore, it is an aspect of the present invention to provide a device that allows convenient access to mathematics tools.

It is a further aspect of the present invention to provide a device that adequately protects sensitive electronics while permitting access to drawing implements.

It is a further aspect of the present invention to provide a device that adequately protects sensitive electronics while allowing visually enhanced stenciling.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a top, plan view of an embodiment of the body of the present invention.

FIG. 2 is a top, plan view of an embodiment of the body of the present invention.

FIG. 3 is a top, plan view of an embodiment of the body of the present invention.

FIG. 4 is a top, plan view of an embodiment of the body of the present invention.

FIG. 5 is a rear, plan view of an embodiment of the body of the present invention.

### DETAILED DESCRIPTION

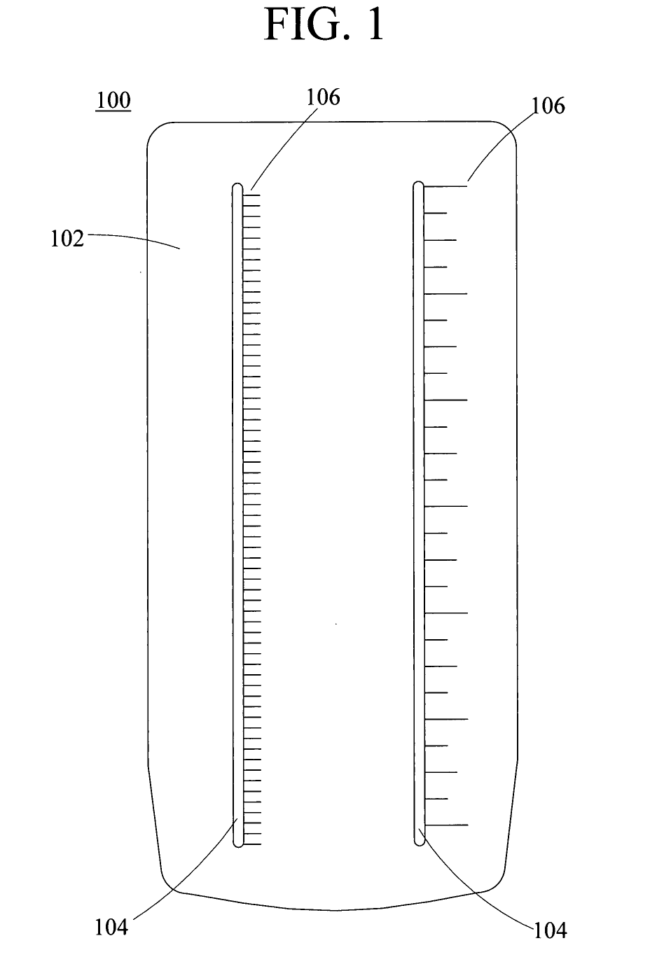

Referring first to FIG. 1, an embodiment of the calculator cover 100 is shown. The calculator cover includes a body 102 shaped to cover a calculator (not shown), which may be of any standard calculator shape and size. The present invention, however, is particularly applicable to the graphing calculators of TEXAS INSTRUMENTS, which include covers capable of supporting significantly sized apertures. Preferred embodiments of the present invention are adapted to fit the TI-84 and TI-89 graphing calculators.

The body 102 includes at least one aperture 104 (i.e. hole) to permit a pencil, pen, or other related drawing utensil access through the body 102. The apertures 104 of the present invention are dimensioned to allow a user to trace a geometric contour. FIG. 1 illustrates an aperture 104 dimensioned to allow a user to trace a straight line. In certain embodiments of the present invention, it will be advantageous to include markings proximate to the apertures. Embodiments of the present invention with linear apertures may include, for example, graduations 106 that relate to distance units that allow a user to confine his line length to a predetermined length.

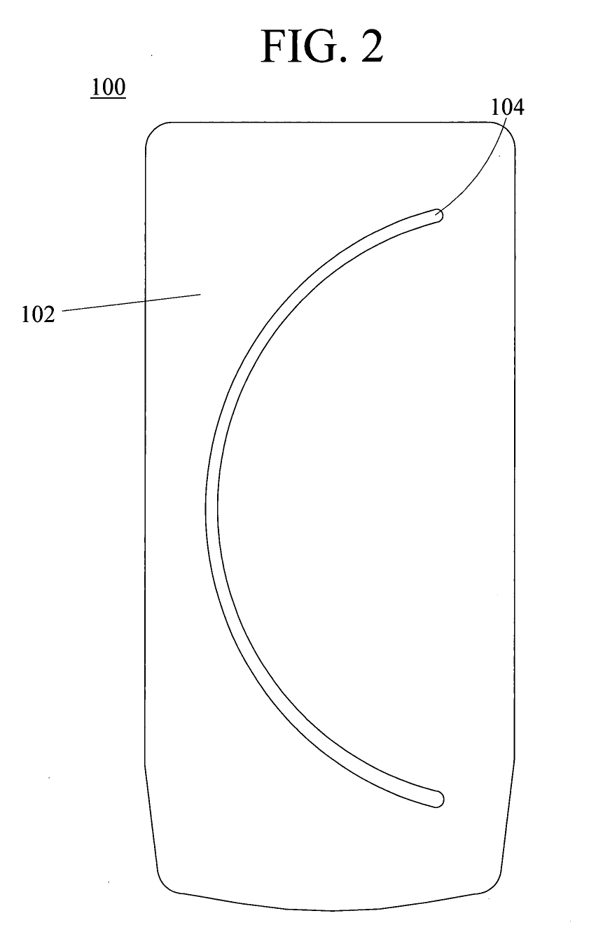

As FIG. 2 shows, the apertures 104 of the present invention are not confined to linear dimensions. Instead, any aperture useful to a mathematician, amateur or professional, may be included in the aperture 104 within the cover body 102. FIG. 2 displays an embodiment of the calculator cover 100 with an aperture 104 corresponding to arc 104, which in certain embodiments may simply allow a user to trace an arc onto a workpiece, or in other embodiments the arc may include graduations proximate thereto that correspond to a measurement in degrees, radians, or other related unit in order to simulate a protractor.

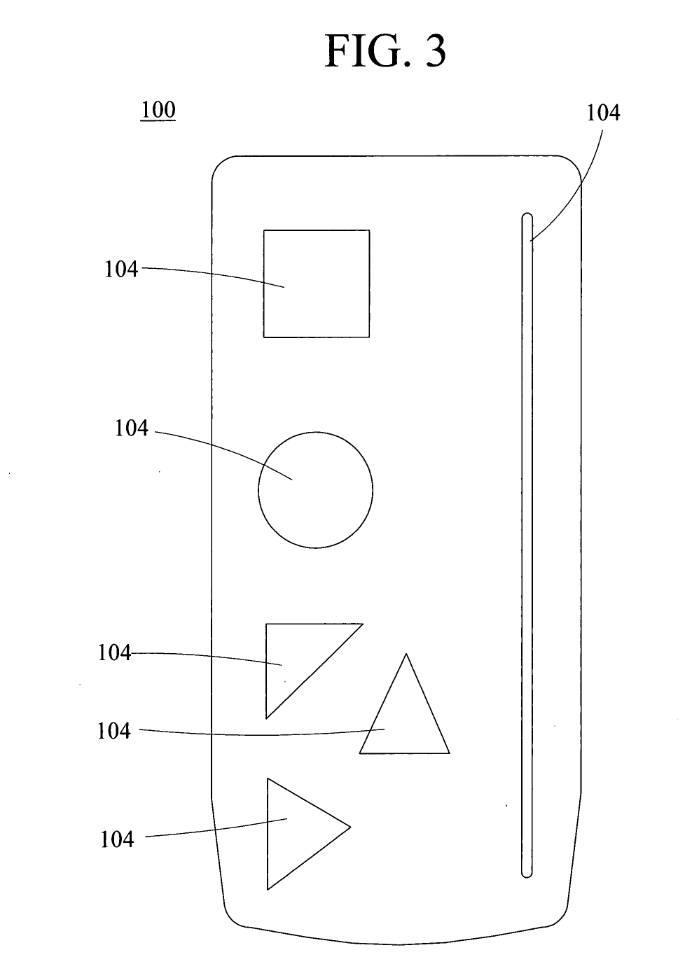

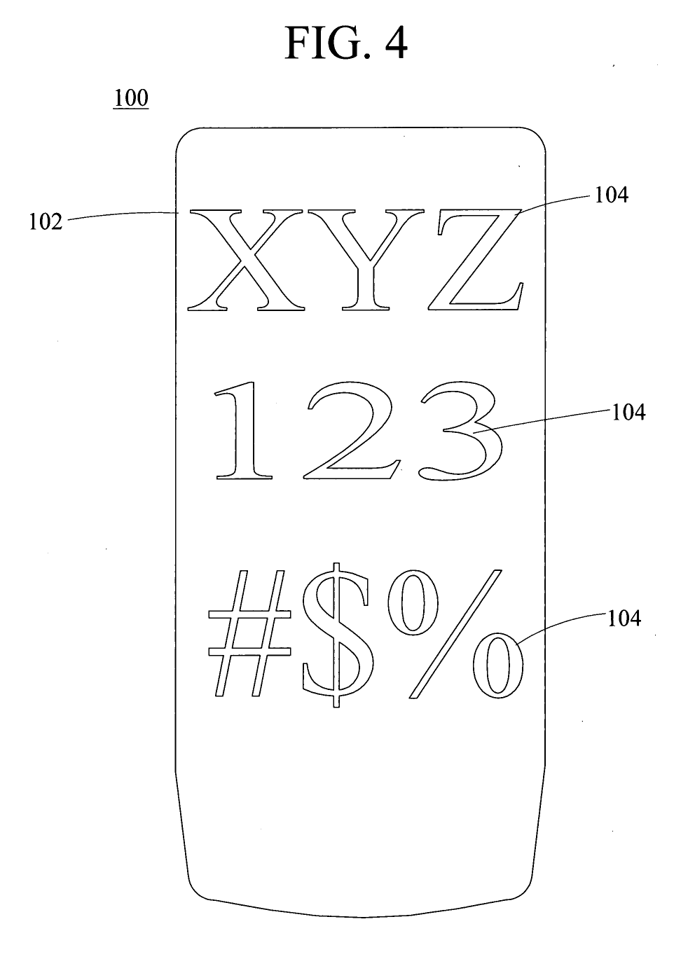

As shown by FIG. 3, the apertures 104 may be varied and highly diversified upon a single calculator cover 100 body 102. The apertures may correspond to a circle, square, rectangle, triangle, pentagon, hexagon, octagon, ellipse, arc, and other simple or complex geometric shapes. As FIG. 4 shows, the aperture(s) 104 may correspond to one or more alphanumeric characters. The apertures of the present invention may correspond to any shape relevant to higher education, particularly math.

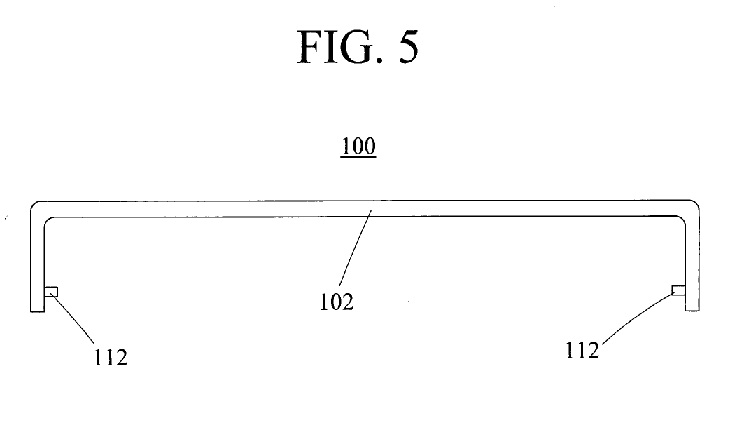

As shown by FIG. 5, the body 102 forms side-mounted protrusions 112 that fit into an indented track within the side of a calculator. The body 102 of the present invention is constructed of a rigid material, e.g. a hard plastic, sufficient to protect the expensive calculator within. It is preferred that the body of the present invention be constructed of a translucent material that yet maintains sufficient thickness suitable for protection. One of foreseen uses of the present invention includes assisting students in creating graphs on graph paper as well protecting any graphing calculator within. It would be of great benefit to the student to be able to see through the body of the present invention onto the graph paper upon which s/he might be sketching. In addition to the uses in connection with graph paper, it is often of the great benefit to be able to visual components currently on the drawing surface likely to be interrelated with the geometric contour soon to be traced.

The preferred material of the present invention that includes both the protection and translucence aspects of preferred embodiments of the present invention is LEXAN polycarbonate, a product of GENERAL ELECTRIC COMPANY. The preferred thickness of the LEXAN that applies the appropriate amount of protection and translucence is approximately 0.24 cm±0.05 cm. In addition to the translucence and rigidity properties, this particular material allows the body of the present invention to include color tinting for a more diverse range of product variations, and this preferred material includes substantial UV protection to assist in shielding any calculator within the present invention from harmful effects from the sun.

As the body of the present invention will require a cover having a thickness sufficient to shield a relatively expensive and internally sophisticated mathematical electronic device, generally irrespective of the material used; the present invention will require an aperture thickness dimensioned to allow a pencil or pen to pass through the body to the drafting surface underneath. That is to say, stencils and other common drafting instruments with interior apertures, need have only minimal aperture width as the body of the stencils (and the like) need not include a thickness adapted to protect electronics—they tend to be nearly two-dimensional. As increase in the body thickness translates into an increase the width of the internal aperture through one traces as most drafting instruments, e.g. pencils and pens, tend to be conical proximate to the location of ink, graphite, or lead exposure. The preferred embodiment of the present invention when it includes the preferred thickness, described above, includes an approximate aperture width of at least 0.3 cm. Such a width has been found to accommodate most pencils, both wooden and mechanical, and many varieties of pen.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A calculator cover for protecting a calculator having side-mounted indentations, said calculator comprising:
a rigid body of thickness sufficient to effectively shield the calculator, said rigid body defining: at least one aperture dimensioned to correspond to a geometric contour, and a pair of interior protrusions.

2. The calculator cover of claim 1 wherein said rigid body is substantially translucent.

3. The calculator cover of claim 2 wherein said rigid body includes UV protection.

4. The calculator cover of claim 3 wherein said rigid body includes a body height of at least 0.15 cm.

5. The calculator cover of claim 4 wherein said aperture includes a width of at least 0.25 cm.

6. The calculator cover of claim 5 wherein said aperture corresponds to the geometric contour of a straight line.

7. The calculator cover of claim 4 wherein said rigid body includes a body height of at least 0.2 cm.

8. The calculator cover of claim 6 wherein said aperture includes a width of at least 0.3 cm.

9. The calculator cover of claim 8 wherein said aperture corresponds to the geometric contour of a straight line.

10. The calculator cover of claim 2 wherein said aperture corresponds to the geometric contour of a straight line.

11. The calculator cover of claim 10 further comprising graduations proximate to said aperture corresponding to a straight line for indicating measurement units.

12. The calculator cover of claim 2 wherein said aperture corresponds to the geometric contour of a geometric shape.

13. The calculator cover of claim 12 wherein said geometric shape is selected from a group consisting of a circle, square, rectangle, triangle, pentagon, hexagon, octagon, ellipse, arc, and combinations thereof.

14. The calculator of claim 12 wherein said aperture corresponds to the geometric contour of an arc of at least 180 degrees, and said body includes graduations indicating a measurement selected from a group consisting of radians, degrees, and combinations thereof.

15. The calculator cover of claim 2 wherein said aperture corresponds to the geometric contour of an alphanumeric shape.

16. A calculator cover for protecting a calculator having side-mounted indentations, said calculator comprising:
a rigid, substantially translucent body of thickness sufficient to effectively shield the calculator, said rigid body defining: at least one aperture having a width of at least 0.15 cm and dimensioned to correspond to a straight line, said aperture having adjacent graduations corresponding to at least one type of measurement unit; and a pair of interior protrusions.

17. The calculator cover of claim 16 wherein said body further comprises at least two apertures dimensioned to correspond to a geometric contour.

18. A calculator cover for protecting a calculator having side-mounted indentations, said calculator comprising:
a rigid body defining: at least one aperture dimensioned to correspond to an arc of at least 180 degrees proximate to graduations indicating a measurement selected from a group consisting of radians, degrees, and combinations thereof, and a pair of interior protrusions.

19. The calculator cover of claim 18 wherein said body further comprises at least two apertures dimensioned to correspond to a geometric contour.
